(19) United States
(12) Patent Application Publication
(10) Pub. No.: US 2013/0268286 A1
(43) Pub. Date: Oct. 10, 2013

(54) PROVIDING PROTOCOL VARIANCES FROM STANDARD PROTOCOLS

(71) Applicants: JEREMY FLORES, LEE'S SUMMIT, MO (US); YEGOR FARIDOVICH HANOV, OVERLAND PARK, KS (US); BRANT ALAN AVONDET, OLATHE, KS (US)

(72) Inventors: JEREMY FLORES, LEE'S SUMMIT, MO (US); YEGOR FARIDOVICH HANOV, OVERLAND PARK, KS (US); BRANT ALAN AVONDET, OLATHE, KS (US)

(73) Assignee: CERNER INNOVATION, INC., OVERLAND PARK, KS (US)

(21) Appl. No.: 13/441,510

(22) Filed: Apr. 6, 2012

(51) Int. Cl. G06Q 50/22

(52) U.S. Cl. 705/2

(57) ABSTRACT

Systems and method for identifying and providing protocol variances are provided. In embodiments, the method includes referencing an ordered protocol associated with a health condition for a patient. Such an ordered protocol includes a plan for a course of health or medical treatment for the health condition of the patient. A standard protocol that corresponds with the ordered protocol is also referenced. Thereafter, the ordered protocol is compared to the standard protocol to identify at least one protocol variance that indicates a portion of the ordered protocol has been adjusted as compared to the standard protocol. Any identified protocol variances are presented, for example, to a user computing device for display to a user.

### BACKGROUND

Clinicians oftentimes use a standardized protocol to place an ordered protocol for a course of treatment for a patient. That is, a clinician may generate an ordered protocol for a patient in accordance with a published or standard method of treatment for a particular healthcare condition. While a standard protocol may generally be appropriate for a health condition, in some cases, a clinician may vary the standard protocol to adapt to particular healthcare needs of the patient. To this end, a clinician may generate a healthcare-related order for a patient that adds, removes, or modifies a portion of a standard protocol so that the ordered protocol is better suited for the patient.

In many cases, recognition of variations to standard protocols may be valuable so that a clinician can appropriately provide care to a patient. For instance, in preparing an ordered protocol for a patient, a clinician may wish to carry forward or repeat a previous ordered protocol. In cases that the previous ordered protocol deviated from a standard protocol, however, recognition of the previous deviation(s) would be beneficial so that the clinician can evaluate whether continuing modifications to a standard protocol is appropriate for this patient. In another example, prior to placing an ordered protocol for a patient, a clinician may verify a proposed ordered protocol prior to finalizing and placing the ordered protocol. In verifying the ordered protocol, review of any variations of the ordered protocol from a standard protocol may better enable the clinician to understand the proposed ordered protocol.

In an electronic medical environment, viewing an ordered protocol for a patient, navigating to a corresponding standard protocol, and performing a manual comparison of the ordered protocol and the standard protocol to identify any variances can be very time consuming and inefficient. Further, such a manual process by a clinician may result in errors as a clinician may overlook an important modification to an ordered protocol.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to providing an analysis of protocol variations from a standard protocol to assist a clinician in making decisions about a patient. When a protocol variance analysis is triggered (either automatically or in response to a user indication in various embodiments), stored standard protocol and variance criteria that are relevant to a particular order or ordered protocol are accessed. The order or ordered protocol is compared to the standard protocol to identify any protocol variances in accordance with the variance criteria. Upon identification of any protocol variances, the protocol variances are presented to a user via a user interface of a user device. The user interface includes a number of protocol variance data that are relevant to an ordered protocol being placed or previous placed by a clinician. In some embodiments, the clinician may select various protocol variance items to maintain in the ordered protocol or in a new ordered protocol.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram illustrating an exemplary system suitable for use in implementing embodiments of the present invention;

FIG. 3 is an illustrative screen display of an exemplary protocol variance report, in accordance with embodiments of the present invention;

FIG. 4 is an illustrative screen display of a first implementation of a protocol variance report, in accordance with an embodiment of the present invention;

FIG. 5 is an illustrative screen display of a second implementation of a protocol variance report, in accordance with an embodiment of the present invention;

FIG. 6 is an illustrative screen display of a third implementation of a protocol variance report, in accordance with an embodiment of the present invention;

FIG. 7 is a flow diagram showing a first method for generating a variance report, in accordance with an embodiment of the present invention;

FIG. 8 is a flow diagram showing a second method for generating a variance report, in accordance with an embodiment of the present invention;

FIG. 9 is a flow diagram showing a third method for generating a variance report, in accordance with an embodiment of the present invention; and

FIG. 10 is a flow diagram showing a fourth method for generating a variance report, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide computerized methods and systems for facilitating protocol variance. Utilizing the methods and systems described herein, variance of an ordered protocol from a standard protocol can be identified and presented. In this regard, a protocol variance can be automatically detected and, subsequently, such a variance can be presented or provided to a user. Accordingly, clinicians can more easily recognize details regarding a healthcare-related order that varies from a standard protocol. In some cases, providing such protocol variances enables a user to efficiently and effectively verify or generate an appropriate ordered protocol for a patient. In other cases, providing such protocol variances enables a user to efficiently view off-protocol orders, that is, ordered protocols, or portions thereof, that vary from a standard protocol.

Accordingly, in one aspect, an embodiment of the present invention is directed to one or more computer storage media having computer-executable instructions embodied thereon for performing a method for providing protocol variances. The method includes referencing an ordered protocol associated with a health condition for a patient, the ordered protocol including a plan for a course of health or medical treatment for the health condition of the patient. A standard protocol that corresponds with the ordered protocol is referenced. The ordered protocol is compared to the standard protocol to identify at least one protocol variance that indicates a portion of the ordered protocol has been adjusted as compared to the standard protocol. The at least one protocol variance is presented.

In another aspect of the invention, an embodiment is directed to a computerized method for providing protocol variances. The method includes receiving an indication to generate a protocol variance report for ordered protocols associated with a health condition during a period of time. A plurality of ordered protocols associated with the health condition that were placed for a plurality of patients during the period of time are referenced. One or more protocol variances associated with the plurality of ordered protocols are identified by comparing the plurality of ordered protocols to a standard protocol associated with the health condition. An analysis of the one or more protocol variances is provided that indicates one or more ordered protocols of the plurality of ordered protocols that are off-protocol from the standard protocol.

In a further aspect, an embodiment is directed to a user interface embodied on at least one computer storage medium. The user interface includes a variance display area configured for receiving an indication to view any protocol variances associated with an ordered protocol, each of the protocol variances providing an indication of a variance of a detail within the ordered protocol compared to a corresponding standard protocol. The user interface further includes a protocol variance report area displaying one or more protocol variances, the protocol variance report area including an item area that indicates one or more items varied from the standard protocol and a detail area that indicates one or more details pertaining to the one or more items varied from the standard protocol.

Having briefly described embodiments of the present invention, an exemplary operating environment suitable for use in implementing embodiments of the present invention is described below.

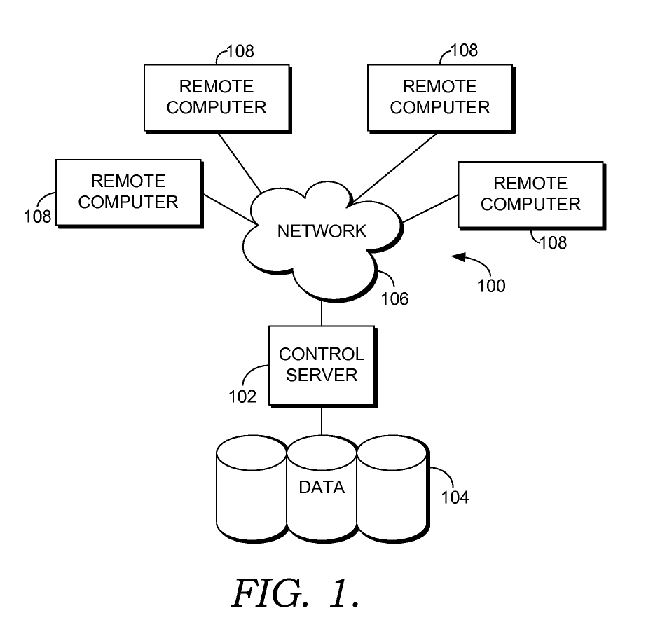

Referring to the drawings in general, and initially to FIG. 1 in particular, an exemplary computing system environment, for instance, a healthcare information computing system, on which embodiments of the present invention may be implemented is illustrated and designated generally as reference numeral 100. It will be understood and appreciated by those of ordinary skill in the art that the illustrated healthcare information computing system environment 100 is merely an example of one suitable computing environment and is not intended to suggest any limitation as to the scope of use or functionality of the invention. Neither should the healthcare information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including memory storage devices.

With continued reference to FIG. 1, the exemplary healthcare information computing system environment 100 includes a general purpose computing device in the form of a control server 102. Components of the control server 102 may include, without limitation, a processing unit, internal system memory, and a suitable system bus for coupling various system components, including database cluster 104, with the control server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer readable media, for instance, database cluster 104. Computer readable media can be any available media that may be accessed by server 102, and includes volatile and nonvolatile media, as well as removable and non-removable media. By way of example, and not limitation, computer readable media may include computer storage media and communication media. Computer storage media may include, without limitation, volatile and nonvolatile media, as well as removable and non-removable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 102. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 104, provide storage of computer readable instructions, data structures, program modules, and other data for the control server 104.

The control server 104 may operate in a computer network 106 using logical connections to one or more remote computers 108. Remote computers 108 may be located at a variety of locations in a medical, healthcare, or research environment, for example, but not limited to, clinical laboratories (e.g., molecular diagnostic laboratories), hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, oncologists, emergency medical technicians, physicians' assistants, nurse practitioners, nurses, nurses' aides, pharmacists, dieticians, microbiologists, laboratory experts, laboratory technologists, genetic counselors, researchers, veterinarians, students, and the like. The remote computers 108 may also be physically located in non-traditional healthcare care environments so that the entire health care community may be capable of integration on the network. The remote computers 108 may be personal computers, servers, routers, network PCs, peer devices, other common network nodes, or the like, and may include some or all of the elements described above in relation to the control server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the control server 102 may include a modem or other means for establishing communications over the WAN, such as the Internet. In a networked environment, program modules or portions thereof may be stored in the control server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) may be utilized.

In operation, a user may enter commands and information into the control server 102 or convey the commands and information to the control server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the control server 102. In addition to a monitor, the control server 102 and/or remote computers 108 may include other peripheral output devices, such as speakers and a printer.

Although many other internal components of the control server 102 and the remote computers 108 are not shown, those of ordinary skill in the art will appreciate that such components and their interconnection are well known. Accordingly, additional details concerning the internal construction of the control server 102 and the remote computers 108 are not further disclosed herein.

Although methods and systems of embodiments of the present invention are described as being implemented in a WINDOWS operating system, operating in conjunction with an Internet-based system, one of ordinary skill in the art will recognize that the described methods and systems can be implemented in any system supporting the receipt and processing of healthcare-related ordered protocols, particularly, oncology ordered protocols. As contemplated by the language above, the methods and systems of embodiments of the present invention may also be implemented on a stand-alone desktop, personal computer, or any other computing device used in a healthcare environment or any of a number of other locations.

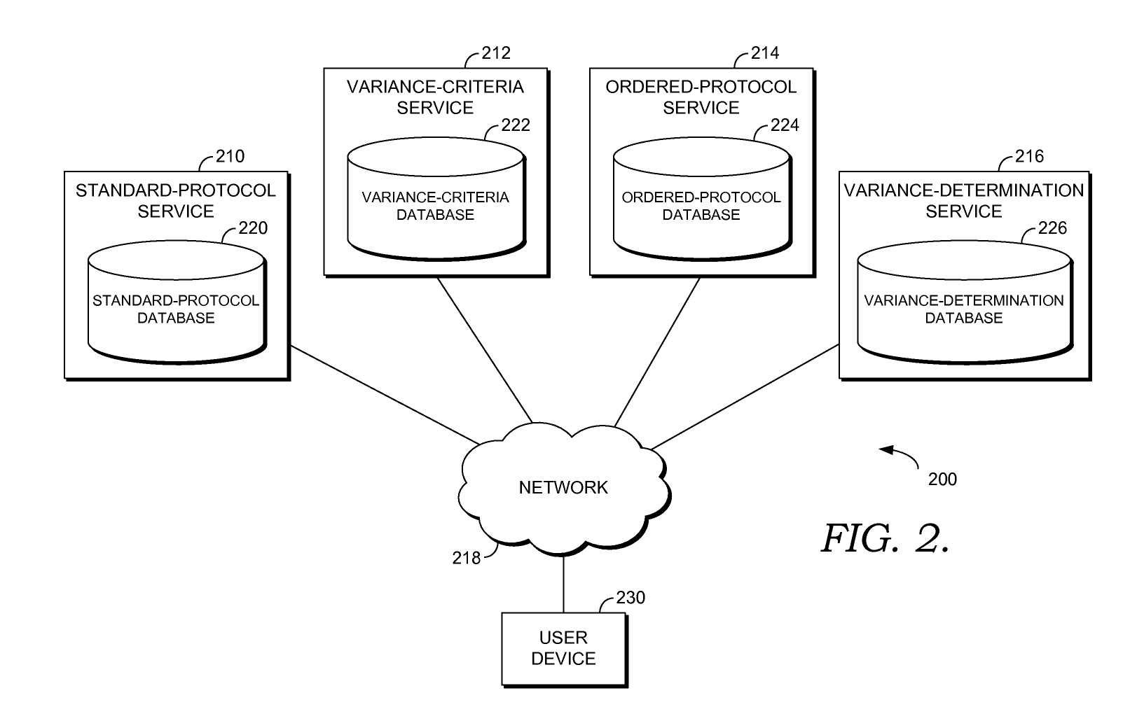

As previously mentioned, embodiments of the present invention relate to computerized methods and systems for use in, e.g., an oncology environment, for facilitating protocol variance (e.g., identifying and/or presenting protocol variances). Embodiments of the present invention introduce protocol variances into the order-placing process and the reporting process (e.g., compliance reporting). With reference to FIG. 2, an exemplary system suitable for use in implementing embodiments of the present invention is shown and designated generally as reference numeral 200.

Protocol variance, as used herein, refers to an addition, a deletion, or a modification of a standard protocol, or a portion thereof. In this way, a protocol variance can be any modification or adjustment applied to a standard protocol associated with a treatment plan. A standard protocol is a standard, or generally accepted, plan for a course of health or medical treatment for a particular health condition. A standard protocol may be identified or designated as such, for instance, by a medical organization, a medical agency, a journal, a group of clinicians, a group of medical researchers, or the like. By way of example, a standard protocol for a first cycle of breast cancer may be standard protocol A, and a standard protocol B may exist for a first cycle of lung cancer. An ordered protocol refers to a plan for a course of health or medical treatment for a particular health condition that has been ordered for a patient or is to be ordered for a patient.

Accordingly, protocol variance is directed to any modification or adjustment made to a standard protocol to arrive at an ordered protocol placed, or to be placed, for a patient. (The terms “individual”, “person”, and “patient” are used interchangeably herein and are not meant to limit the nature of the referenced individual in any way. Rather, the methods and systems described herein are equally applicable, for instance, in a veterinary setting. Further, use herein of the term “patient” is not meant to imply any particular relationship between the individual in question and those defining variance criteria, viewing variance protocols, and/or the like.)

As can be appreciated, a standard protocol and/or an ordered protocol can include any amount of substance or protocol details to convey a treatment plan for a particular health condition. Protocol details may be any data that indicate a health or medical treatment plan. For example, a protocol may include any number of protocol items and corresponding values (e.g., a medication and a dosage/frequency, a procedure to perform and a date, etc.). In a more simple protocol, a standard and/or ordered protocol may be a single medication or drug order (e.g., an order of prednisone to treat an inflammatory disease) and corresponding frequency/dosage. In a more complex protocol, various medications and procedures may be included in a standard and/or ordered protocol (e.g., several medications to prescribe, a laboratory order, etc.).

In embodiments, system 200 includes a standard-protocol service 210, a variance-criteria service 212, an ordered-protocol service 214, a variance-determination service 216, and a user device 230 in communication with one another through a network 218. The network 218 may include, without limitation, one or more local area networks (LANs) and/or wide area networks (WANs). The network 218 may include multiple networks, as well as being a network of networks, but is shown in a more simple form so as to not obscure other aspects of the present invention. Such networking environments are commonplace in offices, enterprise-wide computer networks, intranets, and the Internet. Accordingly, the network 218 is not further described herein.

In some embodiments, one or more of the illustrated components may be implemented as stand-alone applications. In other embodiments, one or more of the illustrated components may be integrated directly into the operating system of the control server 102, a cluster of servers (not shown), and/or the end-user device 206. It will be understood that the components illustrated in FIG. 2 are exemplary in nature and in number and should not be construed as limiting. Any number of components may be employed to achieve the desired functionality within the scope of embodiments herein. Further, components may be located on any number of servers or computing devices.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The standard-protocol service 210 is configured to obtain and/or provide standard protocols for use in identifying protocol variances. Initially, the standard-protocol service 210 obtains standard protocols. Such standard protocols can be received, retrieved, or otherwise obtained. Standard protocols can be input, for example, via any user or user device. As previously mentioned, a standard protocol is a standard, or generally accepted, plan for a course of health or medical treatment for a particular health condition. A standard protocol can electronically represent any protocol that is generally accepted or promoted by a health community. By way of example only, a standard protocol can be an electronic representation of a generally accepted or utilized protocol that is directed to a treatment plan for lung cancer. Such a treatment plan may include, for instance, a medication(s), a procedure(s), a laboratory exam(s), etc. Standard protocols may be designated as such by the health community or portions of the health community (e.g., oncology specialists, researchers, etc.)

Standard protocols can be stored, for example, via a standard-protocol database 220. The database 220 is configured to store information associated with at least one standard protocol. In various embodiments, such information may include, without limitation, a standard-protocol name, one or more protocol statements defining required, desired, or optional protocol data elements or items, one or more values (e.g., frequency, does, date, duration, etc.) associated with a protocol statement, a standard-protocol identifier that uniquely identifies or indicates the standard protocol, and the like. In embodiments, the database 220 is configured to be searchable for one or more protocol statements, protocol data elements or items, and/or associated values stored in association therewith. It will be understood and appreciated by those of ordinary skill in the art that the information stored in the database 220 may be configurable and may include any information relevant to a standard protocol. The content and volume of such information are not intended to limit the scope of embodiments of the present invention in any way. Further, though illustrated as a single, independent component, database 220 may, in fact, be a plurality of databases, for instance, a database cluster, portions of which may reside, for example, on a computing device associated with the standard-protocol service 210, the variance-criteria service 212, the ordered-protocol service 214, the variance-determination service 216, a user computing device, a cloud-computing platform, another external computing device, and/or any combination thereof.

The standard protocols can be accessible by any component, such as the standard-protocol service 210, the variance-criteria service 212, the ordered-protocol service 214, the variance-determination service 216, a user computing device, a cloud-computing platform, another external computing device, and/or any combination thereof. For example, and as described more fully below, the variance-criteria service 212 might access standard protocols to facilitate generating or defining variance criteria and/or the variance-determination service 216 might access standard protocols to determine any protocol variances associated with an ordered protocol or set of ordered protocols, etc.

The variance-criteria service 212 is configured to generate, establish, or define variance criteria. Variance criteria, as used herein, refers to any criteria or rules that can be used to determine whether protocol variance exists. In this regard, variance criteria can indicate, for example, an instance that a modification to a standard protocol is to be considered a protocol variance, an instance that a user is to be alerted to a protocol variance, etc.

In embodiments, a user can designate, define, or establish variance criteria. By way of example, a clinician might input or set a variance criterion indicating that a modification of a particular medication or laboratory test to perform is to result in a protocol variance or a protocol variance alert. Further, individual medical organizations or clinicians may have individual criteria that they use to determine protocol variance and, thus, establish unique variance criteria to detect appropriate protocol variance. For instance, a first medical organization may use a medication dosage modification of above 10% to indicate a protocol variance while a second medical organization may use a medication dosage modification of above 25% to indicate a protocol variance. When an ordered protocol includes a medication variation of 15% difference from a standard protocol, the first medical organization may recognize an occurrence of a protocol variance while the second medical organization does not recognize a protocol variance.

In other embodiments, variance criteria can be automatically determined (e.g., by the variance-criteria service 212). For instance, a particular standard protocol can be analyzed to identify any critical components within the protocol. Variance criteria can then be adapted to include any modification or a particular extent of modification of identified critical components.

In some cases, irrespective of whether variance criteria is designated by a user or automatically determined, the variance-criteria service 212 can reference one or more standard protocols, for example, standard protocols stored in the standard-protocol database 220. Standard protocols can be referenced, for example, so that variance criteria can be input in association therewith or so that the protocols can be analyzed, via a user or a computing device, to establish variance criteria.

As can be appreciated, in some embodiments, variance criteria can generally indicate that any modification of any standard or ordered protocol, or portion thereof, is to result in an identification of a protocol variance and/or an issuance of a protocol variance alert. In other embodiments, variance criteria can be specific to a particular protocol. For example, a first set of variance criteria associated with a particular protocol can include variance criteria indicating a protocol variance if a medication dosage is modified by more than 10%, while a second set of variance criteria associated with a second protocol can include variance criteria indicating a protocol variance if a medication is removed from the protocol. Variance criteria can refer to any number of items, such as, by way of example and not limitation, a previously excluded plan component or item is included; a previously included plan component or item is excluded; an ad hoc order is added to a phase; an ad hoc prescription is added to a phase; an ingredient is added to an IV; an ingredient is removed from an IV; a change is made to values in the order details (e.g. dose, frequency, duration); a change is made to a treatment schedule; a treatment cycle is skipped or repeated; an additional treatment cycle is added to the regimen; or the like. Regimen refers to a plan or regulated course of treatment, such as an oncology regiment treatment. In embodiments, a regimen includes a set of related ordered protocols for treatment of a medical condition.

Variance criteria can be stored, for example, via a variance-criteria database 222. The database 222 is configured to store information associated with at least one variance criteria. In various embodiments, such variance criteria information may include, without limitation, a protocol name or identifier (e.g., a standard-protocol name(s) and/or an ordered-protocol name(s) associated with the variance criteria), a variance-criteria name or identifier (e.g., identifier that uniquely identifies a particular variance criteria or set of variance criteria), a variance element or item, one or more values associated with a variance element or item (e.g., thresholds), and the like. A variance element refers to an indication of an item included within a protocol such as, for example, a medication, a laboratory exam, etc. A value associated with a variance element can be any value including, but not limited to, any modification of an item (e.g., dosage, frequency, duration, etc.), a modification of an item that exceeds a threshold (e.g., a percent threshold, etc.), or the like. Further, as variance criteria can be designated by and specific to a client in some embodiments, variance criteria can be obtained in association with a client (or set of users) and stored in accordance with the client.

In embodiments, the database 222 is configured to be searchable for one or more protocols, variance criteria, and/or associated elements or values stored in association therewith. It will be understood and appreciated by those of ordinary skill in the art that the information stored in the database 222 may be configurable and may include any information relevant to a variance criteria. The content and volume of such information are not intended to limit the scope of embodiments of the present invention in any way. Further, though illustrated as a single, independent component, database 222 may, in fact, be a plurality of databases, for instance, a database cluster, portions of which may reside, for example, on a computing device associated with the standard-protocol service 210, the variance-criteria service 212, the ordered-protocol service 214, the variance-determination service 216, a user computing device, a cloud-computing platform, or another external computing device (not shown), and/or any combination thereof.

Variance criteria can be accessible by any component, such as the standard-protocol service 210, the variance-criteria service 212, the ordered-protocol service 214, the variance-determination service 216, a user computing device, another computing device, and/or any combination thereof. For example, and as described more fully below, the variance-determination service 216 might access (e.g., receive or retrieve) ordered protocols to determine any protocol variances associated with an ordered protocol, set of ordered protocols, etc.

The ordered-protocol service 214 is configured to obtain and/or provide ordered protocols or orders for use in identifying protocol variances. Initially, the ordered-protocol service 214 obtains ordered protocols. Such ordered protocols can be received, retrieved, or otherwise obtained. Ordered protocols can be input, for example, via any user or user device. By way of example only, an ordered protocol can be input into a clinician application to initiate or place an ordered protocol for a patient. As previously mentioned, an ordered protocol is a plan or a course of health or medical treatment for a particular health condition. An ordered protocol can electronically represent any protocol that is specific to a patient for a particular health condition. By way of example only, an ordered protocol can be an electronic representation of a specific protocol that is directed to a treatment plan for lung cancer. An ordered protocol and/or standard protocol can be specific to a cycle of treatment for an oncology health condition or other health condition in which phases of ordered protocols are applicable. Such a treatment plan may include, for instance, a medication(s), a procedure(s), a laboratory exam(s), etc.

Ordered protocols can be stored, for example, via an ordered-protocol database 224. The database 224 is configured to store information associated with at least one ordered protocol. In various embodiments, such information may include, without limitation, an ordered-protocol name, one or more protocol statements defining required or desired protocol data elements or items, one or more values (e.g., frequency, dose, date, duration, etc.) associated with a protocol statement, an order identifier or name, and the like. As previously described, a protocol data element or item refers to an indication of an item included in a protocol, such as, for example, a medication, a laboratory exam, etc. In embodiments, the database 224 is configured to be searchable for one or more protocol statements, data elements or items, and/or associated values stored in association therewith.

It will be understood and appreciated by those of ordinary skill in the art that the information stored in the database 224 may be configurable and may include any information relevant to an ordered protocol. The content and volume of such information are not intended to limit the scope of embodiments of the present invention in any way. Further, though illustrated as a single, independent component, database 224 may, in fact, be a plurality of databases, for instance, a database cluster, portions of which may reside, for example, on a computing device associated with the standard-protocol service 210, the variance-criteria service 212, the ordered-protocol service 214, the variance-determination service 216, a user computing device, a cloud-computing platform, on another external computing device (not shown), and/or any combination thereof.

The ordered protocols can be accessible by any component, such as the standard-protocol service 210, the variance-criteria service 212, the ordered-protocol service 214, the variance-determination service 216, a user computing device, another computing device, and/or any combination thereof. For example, and as described more fully below, the variance-determination service 216 might access (e.g., receive or retrieve) ordered protocols to determine any protocol variances associated with an ordered protocol, set of ordered protocols, etc.

The variance-determination service 216 is configured to determine protocol variances associated with an ordered protocol or set of ordered protocols. In this regard, the variance-determining service 216 is configured to determine, identify, recognize, or detect occurrences of protocol variances. As previously stated, a protocol variance refers to any modification, change, or adjustment from a standard protocol to an ordered protocol generated for a patient (e.g., placed or ready to be placed).

To determine a protocol variance, the variance-determination service 216 can reference an ordered protocol placed or to be placed in association with a patient for a treatment plan for a health condition. Such an ordered protocol may be input into a clinical application via a computing device and, thereafter, referenced. As such, the ordered protocol can be received, retrieved, or otherwise accessed to perform protocol variance analysis. In embodiments, an ordered protocol is referenced upon receiving an indication that an ordered protocol, for instance, has been input into a clinician application. For example, a user may input an ordered protocol and select “verify” or “end” or another indication that an ordered protocol is input and ready for protocol variance analysis. In another example, a user may select “move forward,” “copy,” or “repeat” to pull forward or repeat a previous ordered protocol placed for the patient (e.g., in connection to a previous cycle or point of care visit). Selecting such an icon can initiate protocol variance analysis and thereby result in the ordered protocol being received or retrieved by the variance-determination service 216.

The variance-determination service 216 can also reference a standard protocol that corresponds with the ordered protocol. For instance, the standard protocol and ordered protocol may both be associated with a treatment plan for a patient being treated for a second cycle of treatment associated with a particular cancer. In some cases, a particular standard protocol to reference can be identified or determined by the variance-determination service 216. In other cases, a particular standard protocol to reference may be indicated by another component. For example, a unique identifier indicating a particular standard protocol may be provided along with the corresponding ordered protocol.

The ordered protocol can be compared to the standard protocol to determine whether any protocol variances exist for the ordered protocol. In this way, the variance-determination service 216 compares an ordered protocol to a corresponding standard protocol to determine if the ordered protocol varies in any way from the standard protocol. Such a variance may be, for example, an additional, removed, or modified item within the ordered protocol or a value associated therewith (e.g., a dosage quantity, a frequency, etc.).

In embodiments, the variance-determination service 216 may also reference variance criteria associated with the ordered protocol and/or standard protocol. Such variance criteria can be used to determine whether a protocol variance(s) exists. For instance, variance criteria may require that a medication dosage is adjusted by a specific percentage to qualify as a protocol variance. In another example, variance criteria may require that a specific medication be removed from the ordered protocol to qualify as a protocol variance.

Appropriate variance criteria to reference might be based on, by way of example and not limitation, a client, clinician, or medical organization preparing or placing the ordered protocol, compliance administration administering a protocol variance report, a specific type of protocol (e.g., the standard protocol or ordered protocol), a combination thereof, or the like. In this regard, variance criteria can be user-defined and specific to a client so that ordered protocols can be evaluated based on the variance criteria specified for the client. For example, assume a protocol variance analysis is to be performed for a particular oncology ordered protocol related to lung cancer. In such a case, variance criteria specific to such an ordered protocol might be referenced. As can be appreciated, in some cases, variance criteria may be generalized such that it can be used for any ordered protocol or set of ordered protocols (e.g., any modifications of any medication).

A protocol variance determination may be initiated in any manner. In embodiments, protocol variance is automatically determined upon a user indication to generate, verify, and/or place an ordered protocol for a patient. For example, a user utilizing a clinical application may provide an indication to generate an ordered protocol for a patient. In some cases, to initiate an ordered protocol for the patient, the clinician may provide an indication to copy forward or duplicate a previous ordered protocol. In providing such an indication, the clinician may automatically trigger the variance-determination service 216 to determine any protocol variance associated with the previous ordered protocol and/or the newly generated ordered protocol that duplicates the previous ordered protocol. Initiating such a protocol variance enables a clinician to efficiently view or recognize any item or details within the previous ordered protocol and/or newly generated ordered protocol that diverge from a generally accepted protocol standard.

In another example, a user utilizing a clinical application may provide an indication to verify or submit an ordered protocol to be placed for a patient. In this way, a clinician may trigger the variance-determination service 216 to determine any protocol variance associated with the previous ordered protocol and/or newly generated ordered protocol that duplicates the previous ordered protocol by selecting an icon or button that indicates a desire to view any protocol variances, indicates a desire to view a history or details regarding an ordered protocol, indicates a desire to place an ordered protocol for a patient, or the like.

In yet another example, a user utilizing a clinical application may provide an indication to view any off-protocol orders placed or to be placed for a patient(s). For instance, a variance protocol report or compliance report may be initiated by a user. A variance protocol report or compliance report refers to any report or documentation indicating protocol variances or ordered protocols associated with protocol variances. An organization may want to report on instances that patients are off protocol. For example, a protocol variance report may be desired to track an organization's adherence to standard treatments, to identify patients off-protocol to understand why treatment changes occur, to recognize insurance reimbursement considerations, to identify clinical trial compliance, or the like.

Upon determining protocol variances, the variance-determination service 216 can provide such variances to any computing device(s) for presentation to a user(s). In some cases, protocol variances are returned to a computing device and/or user that provided the ordered-protocol to be analyzed. To this end, a clinician providing an indication to duplicate a previous ordered protocol issued for a patient may be provided with any protocol variances associated with such an ordered protocol. In other cases, protocol variances are returned to a computing device and/or user that differs from the computing device and/or user that provided the ordered-protocol. For instance, assume that a clinician input an ordered protocol for a patient. At a later time, another user, such as a compliance administrator, can provide an indication to view a compliance report that can include any protocol variances associated with the ordered protocol input by the clinician or a set of ordered protocols. As can be appreciated, protocol variances can be presented to users in any manner, some of which will be described in more detail below.

Further, the variance-determination service 216 can facilitate alerts provided to users via a user computing device. Upon recognizing a protocol variance, an alert indicating a protocol variance may be provided to a user via a user computing device. The alert can provide notice to the user that at least a portion of the protocol has been varied. The alert may simply provide awareness of a protocol variance with respect to a particular ordered protocol. Upon recognizing the alert, the user can then navigate a clinical application to view the protocol variances. In other cases, the alert may provide an indication of the protocol variance, such as the protocol item, detail, or value modified, the extent of modification (e.g., 10%, 20%, a color indicating an extent, etc.), or the like.

Protocol variances can be stored, for example, via a protocol-variance database 226. The database 226 is configured to store information associated with at least one protocol variance. In various embodiments, such information may include, without limitation, an indication of the ordered-protocol and/or standard-protocol, an indication of an item(s) varied (e.g., prednisone), an indication of a value(s) varied, an indication of a percent of variance, an indication of the protocol variance (e.g., a unique identifier), and the like. In embodiments, the database 226 is configured to be searchable for one or more items or values stored in association therewith. It will be understood and appreciated by those of ordinary skill in the art that the information stored in the database 226 may be configurable and may include any information relevant to a protocol variance. The content and volume of such information are not intended to limit the scope of embodiments of the present invention in any way. Further, though illustrated as a single, independent component, database 226 may, in fact, be a plurality of databases, for instance, a database cluster, portions of which may reside, for example, on a computing device associated with the standard-protocol service 210, the variance-criteria service 212, the ordered-protocol service 214, the variance-determination service 216, a user computing device, a cloud-computing platform, on another external computing device, and/or any combination thereof.

As can be appreciated, system 200 is functional without any such discussed database. By way of example only, in some embodiments, protocol variances are not stored via a database, such as variance-determination database 226. Rather, protocol variances are dynamically determined and provided without storage in a database thereby reducing the possibility for stale data based on new updates.

As previously mentioned, the system 200 further includes a user device 230 in communication with the standard-protocol service 210, the variance-criteria service 212, the ordered-protocol service 214, and/or the variance-determination service 216 via the network 218. The user device 230 may be associated with any type of computing device, such as computing device 100 described with reference to FIG. 1, for example. Though not shown in FIG. 2, the user device 230 typically includes at least one presentation module configured to present (e.g. display) one or more protocols and/or protocol variances. Such embodiments are more fully described herein below. Further, the user device 230 can include an input module configured to receive input. Typically, input is input via a user interface (not shown) associated with the end-user device, or the like. Additionally, other components not shown may also be included with the system 200. Further, additional components not shown may also be included within any of the standard-protocol service 210, the variance-criteria service 212, the ordered-protocol service 214, and/or the variance-determination service 216, and the user device 230. Any and all such variations are contemplated to be within the scope of embodiments hereof.

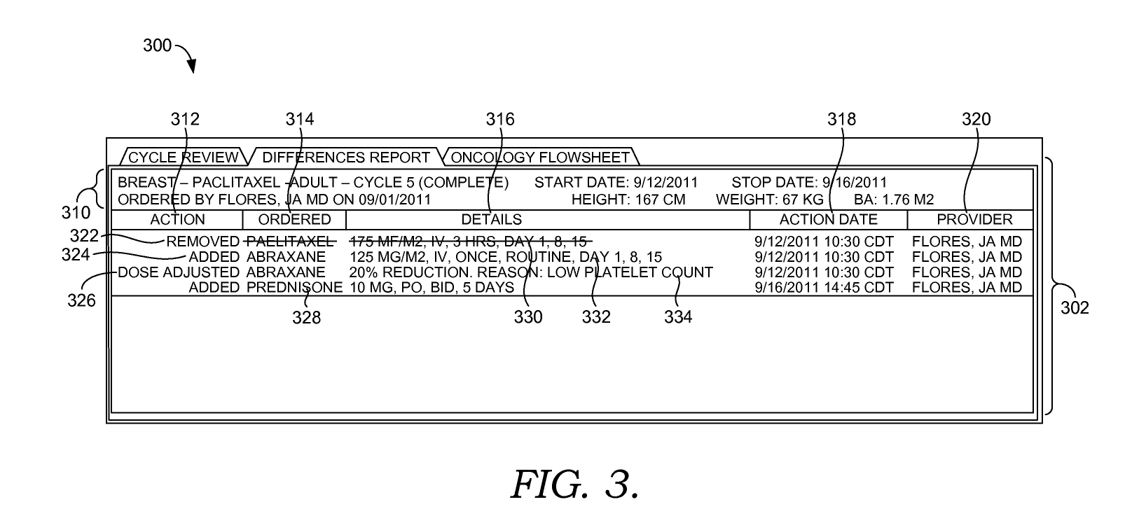

With reference to FIG. 3, an illustrative screen display of an exemplary protocol variance report in accordance with an embodiment of the present invention is illustrated and designated generally as reference numeral 300. The protocol variance report 302 can be associated with a particular ordered protocol for a patient. In other embodiments, the protocol variance report 302 can be associated for a set of ordered protocols for the patient, such as all ordered protocols for the patient, ordered protocols associated with a particular health condition, ordered protocols associated with a particular regimen, etc. The protocol variance report 302 includes an indication of an ordered protocol for a patient 310, an action area 312, an order area 314, a detail area 316, an action date 318, and a provider area 320. Any and all combinations of areas, as well as additional similar areas, are contemplated to be within the scope of embodiments of the present invention.

The indication of the ordered protocol for the patient 310 is configured to identify or indicate the particular order for which protocol variances are displayed. In the illustrated embodiment, the order indication 310 includes a description of the order. The order indication can include other items, such as the clinician preparing or issuing the order, a start date, a stop date, and/or patient data (e.g., height, weight, etc.). Action area 312 is configured to indicate an action applied to a particular item or portion of an ordered protocol. For example, action 322 indicates that the item of “Paclitaxel” is removed from the ordered protocol, action 324 indicates that the item of “Abraxane” is added to the ordered protocol, and action 326 indicates that the dose is adjusted for the item of “Abraxane.”

The order area 314 is configured to provide an indication of an item(s) or portion(s) of an ordered protocol that has been modified, adjusted, added, deleted, etc. In this way, order area 314 provides a listing of any variations to a standard protocol. As illustrated in FIG. 3, item 328 indicates that the portion of the ordered protocol directed to “Prednisone” is a component that is varied from the appropriate standard protocol.

The detail area 316 is configured to provide details regarding any variance to the standard protocol. For example, detail 330 illustrates that the “Paclitaxel” portion of the ordered protocol has been removed from the ordered protocol, as indicated by the strikethrough of the medication. Detail 332 illustrates the details regarding the addition of the “Abraxane” portion of the ordered protocol (e.g., 125 mg/m2, IV, once, routine, day 1, 8, 15). Detail 334 reflects an amount of dose reduction applied to the “Abraxane” portion of the ordered protocol. The action date 318 provides an indication of the date an action is applied, and the provider area 320 provides an indication of the provider that initiated the action.

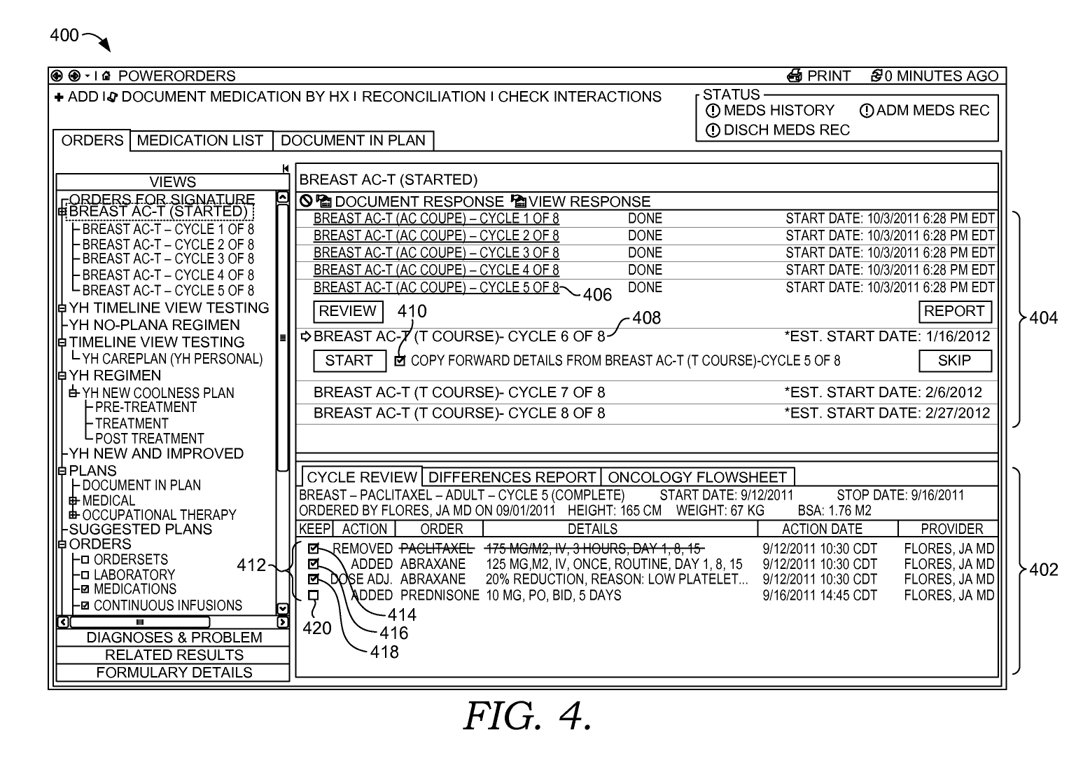

FIG. 4 illustrates an implementation of a protocol variance report in one exemplary embodiment, in accordance with an embodiment of the present invention, and is designated generally as reference numeral 400. As illustrated in FIG. 4, various ordered protocols associated with a medical condition are provided, as indicated by numeral 404. Ordered protocol 406 associated with cycle 5 of 8 is the most recently completed ordered protocol. The current ordered protocol 408 to be placed by a clinician is accordingly associated with cycle 6 of 8.

Assume that the clinician would like to copy forward or repeat ordered protocol 406 as the ordered protocol was recently applied and seemed to provide an acceptable outcome(s). Accordingly, the clinician can select the repeat box 410 to indicate a desire to copy forward ordered details from cycle 5. Such a selection can initiate a protocol variance analysis of such an ordered protocol. The protocol variance report 402 can be included within, or accessible by, the screen used to prepare ordered protocols such that the clinician can review any modifications for the ordered protocol as compared to a standard protocol. In some embodiments, the protocol variance report 402 may also include retention indicators 412 such that the clinician can provide an indication (e.g., via checkboxes) to keep or retain such adjustments to the protocols. As such, in FIG. 4, the protocol variances associated with retention indicators 414, 416, and 418 will be maintained as the ordered protocol is carried forward, and the protocol variance associated with retention indicator 420 will not be carried over in the new ordered protocol.

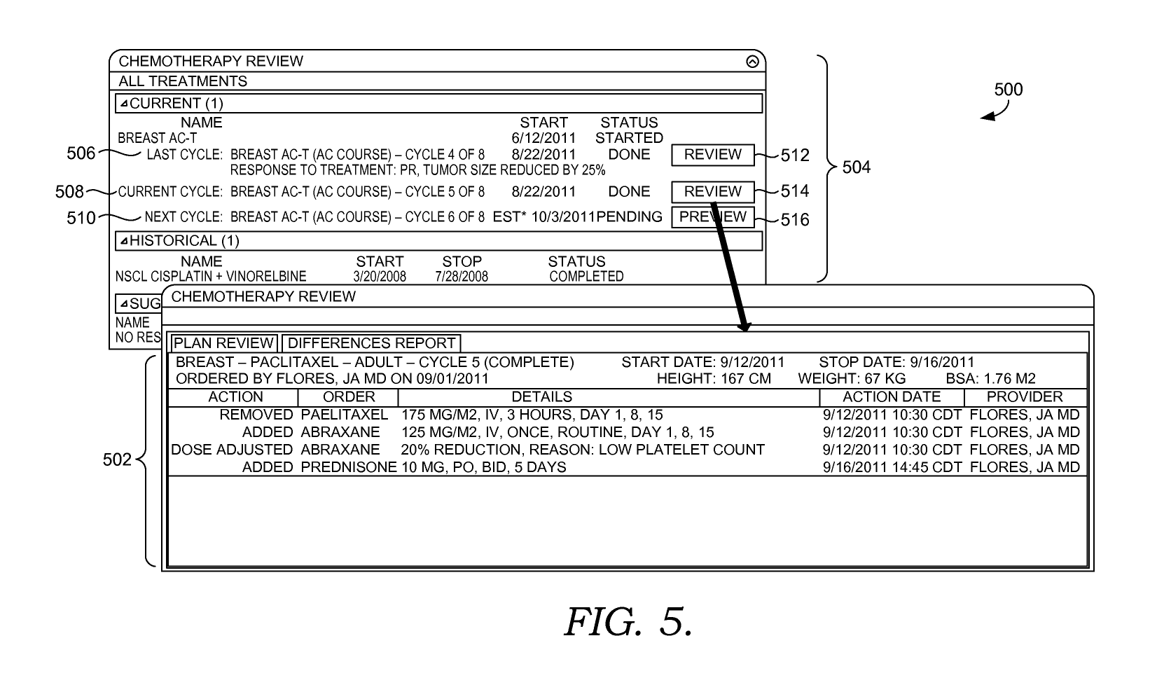

FIG. 5 illustrates another implementation of a protocol variance report in one exemplary embodiment, in accordance with an embodiment of the present invention, and is designated generally as reference numeral 500. As illustrated in FIG. 5, a medical review associated with a medical condition is provided, as indicated by numeral 504. The medical review 504 provides a clinician an opportunity to review patient information, for example, prior to a treatment follow-up visit. Accordingly, a clinician can view information regarding current treatment, for instance, using an oncology summary view. As in FIG. 5, the medical review 504 can include, among other things, a portion directed to the last treatment cycle 506, a portion directed to the current treatment cycle 508, and a portion directed to the next treatment cycle 510. With regard to any treatment cycle (or ordered protocol), a clinician can select a “review” icon or button to view a protocol variance report for the corresponding ordered protocol. By way of example, review button 512 can be selected to view a protocol variance report associated with the last treatment cycle 506, review button 514 can be selected to view a protocol variance report associated with current treatment cycle 508, and review button 516 can be selected to view a protocol variance report associated with the next treatment cycle 510.

By way of example, assume a clinician selects review button 514 to view a protocol variance report associated with current treatment cycle 508. As a result, protocol variance report 502 is presented to the clinician. The protocol variance report 502 illustrates any adjustments made to the current ordered protocol that are varied from an appropriate standard protocol, as described in FIG. 3.

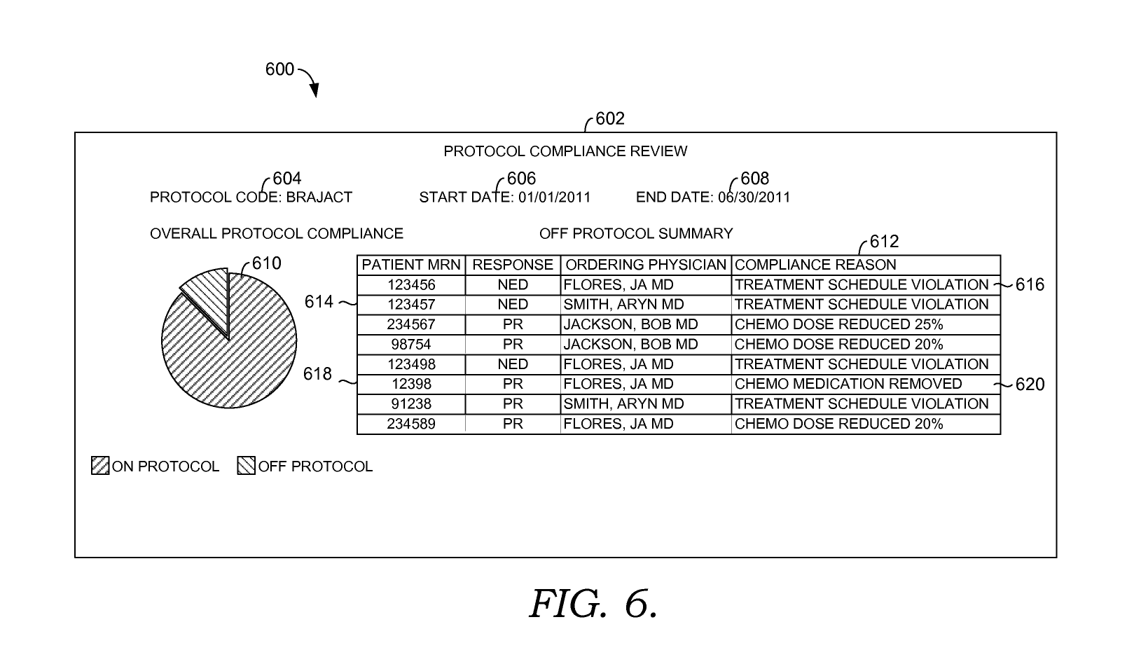

FIG. 6 illustrates another implementation of a protocol variance report in one exemplary embodiment, in accordance with an embodiment of the present invention, and is designated generally as reference numeral 600. Assume that variance criteria are established that include a chemo medication removed from an ordered protocol, dose reduction on chemo medication that is greater than 10% within an ordered protocol, and an alteration in treatment schedule that is greater than one day. Such criteria can be established for analyzing a specific ordered protocol. By way of example, a client can define the variance criteria for use in comparing an ordered protocol to a standard protocol. In such a case, a client might define a variance criteria as any dose reduction greater than or equal to 10% to result in a protocol variance such that a protocol variance is reported if there is a dose reduction greater than or equal to 10%.

Now assume that a quality coordinator desires to review protocol compliance for a protocol standard of BRAJACT to review any implications in cost of care and/or patient outcomes. BRAJACT is a commonly ordered protocol that is a BCCA (BC Cancer Agency) protocol for adjuvant therapy for breast cancer.

The quality coordinator can select to view protocol compliance and be presented with the protocol variance report 602. The protocol variance report 602 indicates the protocol code 604 being analyzed, the start date 606 of the analysis, and the end date 608 of the analysis. The protocol variance report can also display a chart 610 or other indication of a percent of overall protocol compliance for the standard protocol 604. The off-protocol summary 612 provides the quality coordinator with a summary of the variances from the standard protocol in accordance with the established variance criteria. For example, off-protocol item 614 illustrates that the reason for the non-compliance for patient identifier “123456” is a treatment schedule violation 616. As another example, off-protocol item 618 illustrates that the reason for the non-compliance for patient identifier “12398” is removal of chemo medication 620.

Such a protocol variance report can be used to analyze overall compliance, identify patterns, identify details of reasons for order modifications from a defined standard, or the like. As can be appreciated, a protocol variance report can provide any type of detail and is not limited to the details illustrated herein.

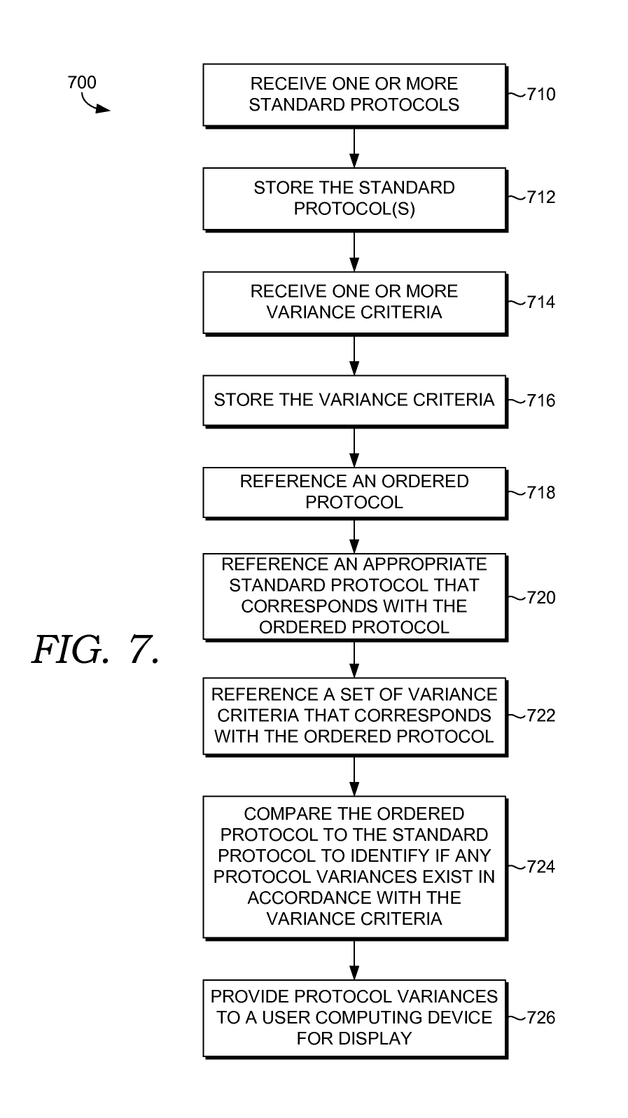

Turning now to FIG. 7, a flow diagram showing a method for generating a variance report, in accordance with an embodiment of the present invention, is illustrated and designated generally as reference numeral 700. Method 700 may be implemented on the above-described exemplary computing system environment (FIG. 2) and, by way of example only, may be utilized by a clinician to view protocol variances.

Initially, as indicated at block 710, one or more standard protocols are received. The standard protocols, for example, might be input by a clinician, administrator, etc. At block 712, the one or more standard protocols are stored. At block 714, one or more variance criteria are received. Variance criteria can be received via input by a clinician, administrator, etc. As can be appreciated, variance criteria can be associated with a particular protocol, workflow, client, etc. such that it is adapted to the particular needs of the entity. At block 716, the one or more variance criteria are stored.

At block 718, an ordered protocol is referenced. An ordered protocol may be received or retrieved, for example, based on a user indication to view any protocol variances. Subsequently, at block 720, an appropriate standard protocol that corresponds with the ordered protocol is referenced. Further, an appropriate set of variance criteria that corresponds with the ordered protocol is also referenced, as indicated at block 722. In this regard, variance criteria and a standard protocol that correspond with the ordered protocol are referenced so that an analysis of the ordered protocol can be performed.

At block 724, the ordered protocol is compared to the standard protocol to identify if any protocol variances exist in accordance with the variance criteria. Thereafter, at block 726, identified protocol variances are provided to a user computing device for display to a user.

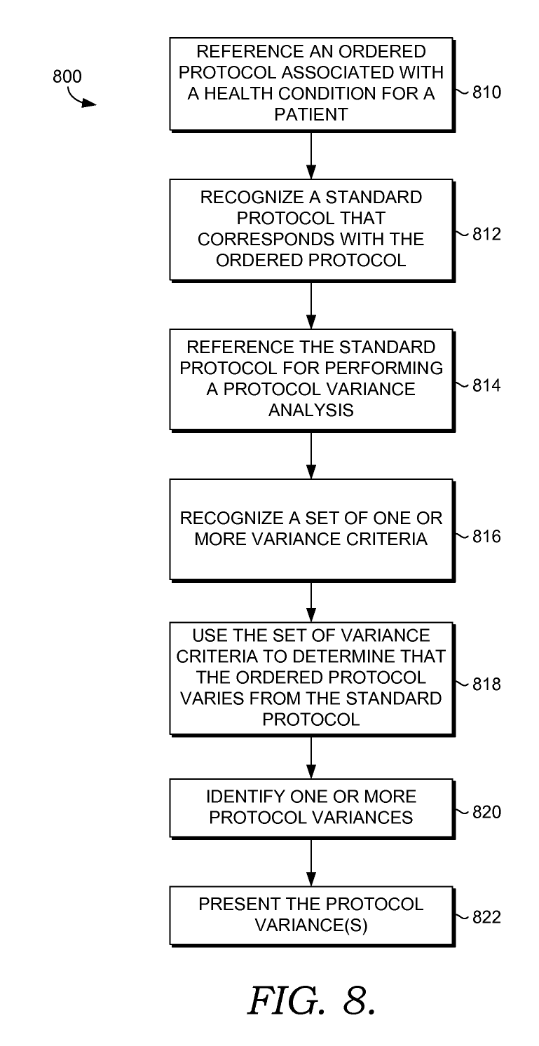

With reference to FIG. 8, a flow diagram showing a method for generating a variance report, in accordance with an embodiment of the present invention, is illustrated and designated generally as reference numeral 800. Method 800 may be implemented on the above-described exemplary computing system environment (FIG. 2) and, by way of example only, may be utilized by a clinician to view protocol variances. In embodiments, method 800 is dynamically performed upon receiving a user indication or automatically.

Initially, as indicated at block 810, an ordered protocol associated with a health condition for a patient is referenced. In one embodiment, the ordered protocol has been placed for the patient. In such a case, a clinician may be reviewing the previously submitted ordered protocol. In another embodiment, the ordered protocol may be prepared to be placed, but not yet issued. In this instance, a clinician may desire to review an ordered protocol prior to submitting the ordered protocol for the patient. At block 812, a standard protocol that corresponds with the ordered protocol is recognized. An appropriate standard protocol might be recognized based on a unique identifier included in the ordered protocol for the patient. Alternatively, an appropriate standard protocol might be recognized based on the health condition associated with the ordered protocol. In this regard, the health condition associated with the patient might be recognized and, thereafter, used to identify an appropriate standard protocol. Any other method of identifying an appropriate standard protocol can be used in embodiments of the present invention. For example, a standard protocol might be identified by a general comparison to find a standard protocol that is similar to the items included within the ordered protocol.

Upon recognizing an appropriate standard protocol, such a standard protocol is referenced for performing a protocol variance analysis, as indicated at block 814. At block 816, a set of one or more variance criteria that corresponds with the ordered protocol and/or standards protocol is recognized. An appropriate set of variance criteria may be recognized in any manner, such as, for example, a unique identifier associated with the standard protocol or the protocol variance analysis.

At block 818, the set of variance criteria is used to determine that the ordered protocol varies from the standard protocol. At block 820, one or more protocol variances are identified. A protocol variance may indicate that an item of the ordered protocol has been modified in some manner (e.g., a dose, a frequency, an occurrence, a duration, etc.), an item of the ordered protocol has been added, or an item of the ordered protocol has been deleted.

At block 822, the one or more protocol variances are presented. Accordingly, the protocol variances can be provided to another computing device such that the variances can be displayed for viewing by a user. As can be appreciated, initiation of a protocol variance analysis can occur automatically (e.g., upon a lapse of a predetermined time duration, at a specific time or time interval, etc.) or upon an indication by a user to view any protocol variances.

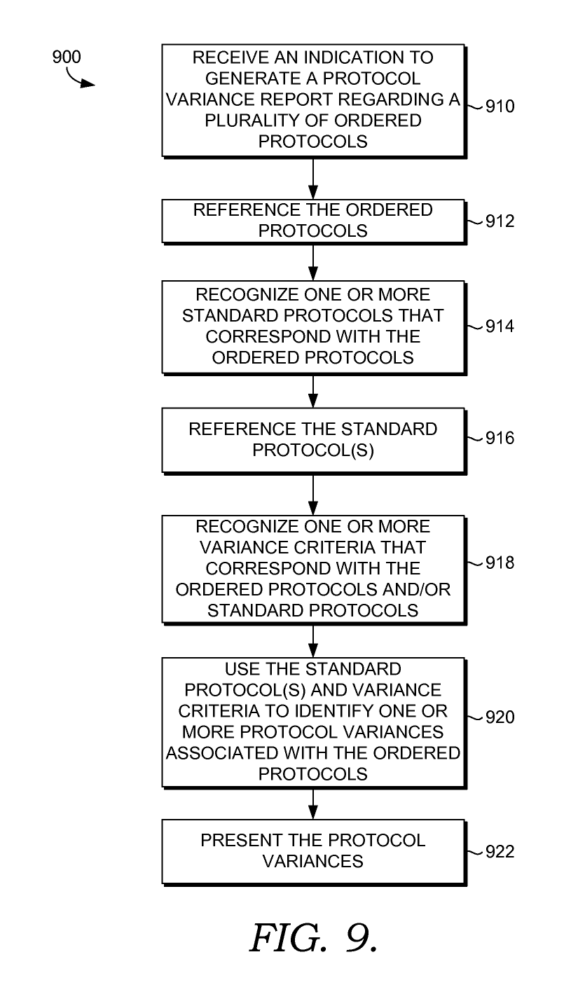

With reference to FIG. 9, a flow diagram showing a method for generating a variance report, in accordance with an embodiment of the present invention, is illustrated and designated generally as reference numeral 900. Method 900 may be implemented on the above-described exemplary computing system environment (FIG. 2) and, by way of example only, may be utilized by a clinician to view protocol variances.

Initially, as indicated at block 910, an indication to generate a protocol variance report regarding a plurality of ordered protocols is received. In embodiments, the ordered protocols to analyze may be based on, for example, any ordered protocol placed within a particular time frame, any ordered protocol associated with a specific health condition(s), any ordered protocols prepared or issued by a specific clinician(s) or health organization, etc. At block 912, the plurality of ordered protocols are referenced. At block 914, one or more standard protocols that correspond with the plurality of ordered protocols are recognized. An appropriate standard protocol might be recognized based on a unique identifier included in an ordered protocol for the patient. Alternatively, an appropriate standard protocol might be recognized based on the health condition associated with an ordered protocol. In this regard, the health condition associated with the patient might be recognized and, thereafter, used to identify an appropriate standard protocol. Any other method of identifying an appropriate standard protocol can be used in embodiments of the present invention. For example, a standard protocol might be identified by a general comparison to find a standard protocol that is similar to the items included within the ordered protocol.

Upon recognizing an appropriate standard protocol(s), such a standard protocol(s) is referenced for performing a protocol variance analysis for the plurality of ordered protocols, as indicated at block 916. At block 918, a set of one or more variance criteria that correspond with the ordered protocol(s) and/or standards protocol(s) is recognized. An appropriate set of variance criteria may be recognized in any manner, such as, for example, a unique identifier associated with the standard protocol or the ordered protocol.

At block 920, the variance criteria and the standard protocol(s) are used to identify one or more protocol variances associated with the plurality of ordered protocols. A protocol variance may indicate that an item of the ordered protocol has been modified in some manner (e.g., a dose, a frequency, an occurrence, a duration, etc.), an item of the ordered protocol has been added, or an item of the ordered protocol has been deleted.

At block 922, the one or more protocol variances are presented. Accordingly, the protocol variances can be displayed or provided to another computing device such that the variances can be displayed for viewing by a user. As can be appreciated, initiation of a protocol variance analysis can occur automatically (e.g., upon a lapse of a predetermined time duration, at a specific time or time interval, etc.) or upon an indication by a user to view any protocol variances. The protocol variances can be presented in any format or manner. In some cases, the protocol variances may be presented as an overall protocol compliance, that is, an indication of a percent of the number of off-protocol orders compared to the total number of ordered protocols analyzed. In other cases, the protocol variances can be presented in any manner, such as, for example, a listing of protocol variances based on patient, ordering clinician, date, non-compliance reason, association with medical organization, health condition, standard protocol, or the like.

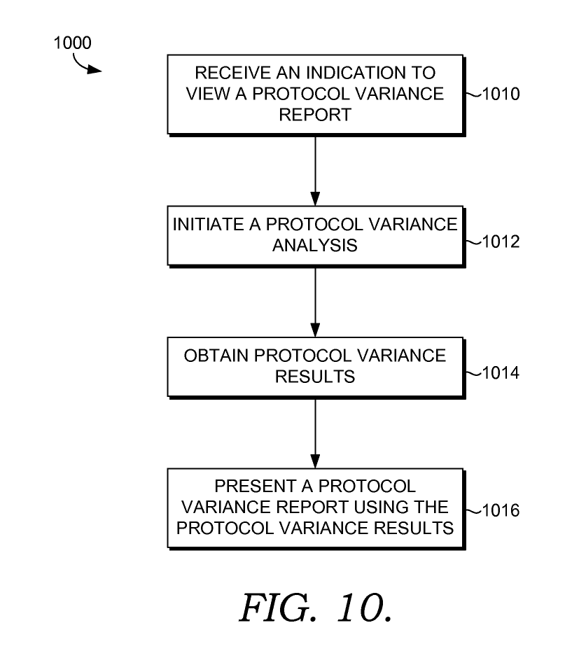

Turning now to FIG. 10, a flow diagram showing a method for generating a variance report, in accordance with an embodiment of the present invention, is illustrated and designated generally as reference numeral 1000. Method 1000 may be implemented on the above-described exemplary computing system environment (FIG. 2) and, by way of example only, may be utilized by a clinician to view protocol variances.

Initially, as indicated at block 1010, an indication to view a protocol variance report is received. In one example, a clinician may select to view a protocol variance report while reviewing a current treatment, for example, using an oncology summary view. In another example, a clinician may select to view a protocol variance report by selecting to copy details from a previous cycle to order a new cycle of treatment. In yet another example, a quality coordinator may select to view a protocol variance report for ordered protocols placed within a certain period of time. At block 1012, a protocol variance analysis is initiated. Subsequently, at block 1014, protocol variance results are obtained. The protocol variance results are used to present a protocol variance report, as indicated at block 1016.

In some implementations, upon displaying a protocol variance report containing indications for protocol variances, feedback regarding the protocol variances is received. For instance, assume that a clinician initially selected to view a protocol variance report by selecting to copy details from a previous cycle to order a new cycle of treatment. Upon displaying the protocol variance report, a user may select which of the protocol variances the user wishes to continue to the new cycle of treatment. Alternatively, the user may select the protocol variances the user does not wish to continue to the new cycle of treatment.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated and within the scope of the claims.

1. One or more computer storage media having computer-executable instructions embodied thereon for performing a method for providing protocol variances, the method comprising:
referencing an ordered protocol associated with a health condition for a patient, the ordered protocol including a plan for a course of health or medical treatment for the health condition of the patient, wherein the ordered protocol is specified based on an indication to use a previously ordered protocol placed for the patient such that the ordered protocol is the same as the previously ordered protocol;
referencing a standard protocol that corresponds with the ordered protocol;
comparing the ordered protocol to the standard protocol to identify at least one protocol variance that indicates a portion of the ordered protocol has been adjusted as compared to the standard protocol; and
presenting the at least one protocol variance.

2. The media of claim 1, wherein the at least one protocol variance is identified using variance criteria that corresponds with the ordered protocol.

3. The media of claim 2, wherein each of the variance criteria indicates a detail within a protocol that, if adjusted, results in identification of a protocol variance.

4. The media of claim 2, wherein the variance criteria are specific to a health organization.

5. The media of claim 1, wherein the ordered protocol is referenced upon receiving an indication to copy forward the ordered protocol.

6. The media of claim 1, wherein the ordered protocol is referenced upon receiving an indication to review the ordered protocol.

7. The media of claim 1 further comprising recognizing the standard protocol to utilize.

8. The media of claim 7, wherein the standard protocol is recognized using a unique identifier associated with the ordered protocol.

9. The media of claim 1, wherein the variance protocols are presented to a user device for presentation to a user of the user device.

10. The media of claim 1, wherein the portion of the ordered protocol has been adjusted by modifying, deleting, or adding an item or value associated therewith within the ordered protocol.

11-15. (canceled)

16. A user interface embodied on at least one computer storage medium, the user interface comprising:
a variance display area configured for receiving an indication to view any protocol variances associated with an ordered protocol, each of the protocol variances providing an indication of a variance of a detail within the ordered protocol compared to a corresponding standard protocol; and
a protocol variance report area displaying one or more protocol variances, the protocol variance report area including
(1) an item area that indicates one or more items varied from the standard protocol and a detail area that indicates one or more details pertaining to the one or more items varied from the standard protocol; and
(2) a retention area configured for receiving one or more indications to maintain in a new ordered protocol a variance associated with each of the one or more items.

17. (canceled)

18. The user interface of claim 16, wherein the protocol variance report area further comprises an action area that indicates one or more actions applied to the one or more items varied from the standard protocol.

19. The user interface of claim 18, wherein each of the one or more actions comprises a remove an item action, an add an item action, or a modification of an item action.

20. The user interface of claim 16, wherein the ordered protocol has been placed for a patient having a health condition.

21. One or more computer storage devices having computer-executable instructions embodied thereon for performing a method for providing protocol variances, the method comprising:
receiving an indication to repeat use of an ordered protocol associated with a health condition previously placed for a patient to generate a new ordered protocol, the ordered protocol including a plan for a course of health or medical treatment for the health condition of the patient that was previously generated;
comparing the ordered protocol to a standard protocol to identify at least one protocol variance that indicates a portion of the ordered protocol has been adjusted as compared to the standard protocol;
presenting an indication of each of the at least one protocol variance, each of the indications of the protocol variances including an action previously applied by a clinician to result in the protocol variance;
receiving an indication to retain a protocol variance for the new ordered protocol; and
generating the new ordered protocol including the protocol variance to be retained.
